(19) United States
(12) Patent Application Publication
(10) Pub. No.: US 2025/0225888 A1
(43) Pub. Date: Jul. 10, 2025

(54) SYSTEM AND METHOD PROVIDING AUTOMATED FEEDBACK FOR WRITERS

(71) Applicant: ThinkCerca.com, Inc., Chicago, IL (US)

(72) Inventors: Eileen Murphy, Chicago, IL (US); Harry A. Layman, Chicago, IL (US); Boxing Li, Chicago, IL (US); Q. Ethan McCallum, Chicago, IL (US); Liujing Ren, Chicago, IL (US); Matt Garner, Chicago, IL (US); Nelson Galvan, Chicago, IL (US); Lorenzo Matta, Chicago, IL (US)

(21) Appl. No.: 19/013,636

(22) Filed: Jan. 8, 2025

Related U.S. Application Data
(60) Provisional application No. 63/619,008, filed on Jan. 9, 2024.

(51) Int. Cl. G09B 5/08; G06F 40/20

(52) U.S. Cl. CPC G09B 5/08; G06F 40/20

(57) ABSTRACT

A computer-based system and method provides feedback to a student in response to a student text for a provided lesson. An evaluation request including student text response to a lesson passage, a writing prompt, a student identifier, and a lesson identifier is received for evaluation of the student text response. An evaluation rubric is selected from rubrics indexed by the student grade level, student the lesson objective, and/or the lesson identifier. An evaluation data structure corresponding to the request for evaluation is initialized. A large language model (LLM) prompt is formulated based on the evaluation request and the evaluation rubric and provided to an LLM. The evaluation data structure is updated with the response from the LLM and converted to feedback text strings which are presented to the student in the context of the student text response.

### CROSS-REFERENCE TO RELATED APPLICATIONS

This application claims the benefit of U.S. Provisional Patent Application Ser. No. 63/619,008, filed Jan. 9, 2024, entitled “AUTOMATED FEEDBACK FOR WRITERS,” which is incorporated by reference herein in its entirety.

### FIELD OF THE INVENTION

The present invention relates to computer-based educational tools, and more particularly, is related to automatically providing instructional feedback upon receipt of a writing sample.

### BACKGROUND OF THE INVENTION

Literacy rates in the United States have been stagnating or declining for several years, even before the COVID-19 pandemic disrupted education globally, with a significant proportion of students scoring below the basic level in reading. This indicates a need to support literacy development.

Students must acquire critical literacy skills, including reading a range of rigorous texts, thinking critically about them, and responding effectively through writing, speaking, and other forms of communication. Argumentative writing, in particular, requires students not only to learn the conventions of a writing genre but also to develop complex reasoning and construct arguments supported by claims, evidence, and logical reasoning. This skill is central to the Common Core standards (2010), which call for students to support claims with logical reasoning and relevant evidence. However, many students struggle to achieve mastery in argumentative writing, even at the college level. The inability to construct cohesive arguments can hinder success across disciplines.

Teachers play a crucial role in facilitating writing development, and face significant barriers balancing instructional planning, grading, and individualized feedback. Grading writing assignments may be time-intensive, and it may be challenging to provide consistent feedback to foster student growth. Timely feedback grounded in clear pedagogical frameworks can enhance student outcomes, yet may involve significant time and effort.

Automated writing feedback systems have emerged to address these challenges, but existing technologies have fallen short. Most systems focus on identifying basic elements of writing, such as claims and evidence, using generic definitions that do not contextualize feedback within a developmental framework, leaving students without sufficient support. Moreover, current tools are frequently limited to either fully automated scoring, which can provide immediate but superficial feedback, or teacher-mediated systems, which deliver depth but sacrifice speed. Therefore, there is a need in the industry to address some of the above mentioned challenges.

### SUMMARY OF THE INVENTION

Embodiments of the present invention provide a system and method for providing automated feedback for writers. Briefly described, the present invention is directed to a computer-based system and method that provides feedback to a student in response to a student text for a provided lesson. An evaluation request including student text response to a lesson passage, a writing prompt, a student identifier, and a lesson identifier is received for evaluation of the student text response. An evaluation rubric is selected from rubrics indexed by the student grade level, the lesson objective, and/or the lesson identifier. An evaluation data structure corresponding to the request for evaluation is initialized. A large language model (LLM) prompt formulated based on the evaluation request and the evaluation rubric is provided to an LLM. The evaluation data structure is updated with the response from the LLM and converted to feedback text strings which are presented to the student in the context of the student text response.

Other systems, methods and features of the present invention will be or become apparent to one having ordinary skill in the art upon examining the following drawings and detailed description. It is intended that all such additional systems, methods, and features be included in this description, be within the scope of the present invention and protected by the accompanying claims.

### BRIEF DESCRIPTION OF THE DRAWINGS

FIG. 1 depicts an example communication system that includes an example server and a number of example client-side computing devices, in accordance with at least one embodiment.

FIG. 2 depicts an example structure of the example server of FIG. 1, in accordance with at least one embodiment.

FIG. 3 depicts an example structure of an example one of the client-side computing devices of FIG. 1, in accordance with at least one embodiment.

FIG. 4A is a block diagram of an architecture for an exemplary first embodiment automated feedback system that may be implemented in the system of FIG. 1.

FIG. 4B is a block diagram of an architecture for an exemplary second embodiment automated feedback system that may be implemented in the system of FIG. 1.

FIG. 5 is a sequence diagram showing a chain of events in an exemplary feedback request.

FIG. 6 is a screenshot of a client device showing the graphical user interface displaying a lesson writing prompt.

FIG. 7 shows the view of FIG. 6 indicating a response to the writing prompt.

FIG. 8 is a screenshot of the client device showing the graphical user interface displaying a lesson writing prompt review screen.

FIG. 9 shows a screen shot of the client device displaying the automatically generated feedback to the student response.

FIG. 10 is a schematic diagram illustrating an example of a system for executing functionality of the present invention.

FIG. 11 is a table representing an example of a rubric that relates to argumentative writing.

Like reference characters, if any, refer to like elements.

### DETAILED DESCRIPTION

This document uses a variety of terminology to describe various concepts. Unless otherwise indicated, the following terminology, and variations thereof, should be understood as having meanings that are consistent with what follows.

For example, the term, “ThinkCERCA” refers to the applicant of the current application. When used to describe a particular element, feature, or aspect, it is intended to convey the notion that what is being described is one particular example of potentially many ways of implementing the concepts being conveyed. For example, the phrase “ThinkCERCA Automated Feedback System” is intended to convey the notion that what is being described is one particular example of potentially many systems (e.g., Automated Feeback Systems (AFS)) that should be considered within the scope of what is being conveyed herein.

The phrase “machine learning,” unless otherwise indicated, refers to computer-implemented computational methods that represent a subfield of artificial intelligence (AI) that enables a computer to learn to perform tasks by analyzing a large dataset without being explicitly programmed. Forms of machine learning include, for example, supervised, unsupervised, and reinforcement machine learning.

The phrase “natural language processing” (e.g., NLP), unless otherwise indicated, refers to computer analysis and/or generation of natural language text. An NLP algorithm may give a computer the ability to support and/or manipulate human language. NLP may involve processing natural language datasets (e.g., text or speech corpora) with rule-based or probabilistic machine learning approaches, for example. The goal is generally for the computer to “understand” the contents of a document, including any contextual nuance of the language in the document.

The phrase “sentence similarity algorithms” refers to computer-implemented processes that produces metrics that defining semantic similarity between sets of documents, sets of terms, etc. where the idea of distance between items (e.g., sets of documents) is based on a likeness in their meaning or semantic content and not simply lexicographical similarity. Computer-implemented sentence similarity algorithms utilize mathematics to estimate the strength of a semantic relationship between units of language, concepts, or instances, for example, with a numerical descriptor produced in view of the comparison of information supporting their meaning and/or describing their nature.

The phrase “language model,” unless otherwise indicated, refers to a computer-implemented machine learning model that aims to predict and/or generate plausible language. The phrase “large language model” (LLM) refers to a language model that is notable for its ability to achieve general-purpose language understanding and generation. LLMs generally acquire these capabilities by learning statistical relationships from text documents during intensive training process. LLMs may be implemented using artificial neural networks.

The term “tokenization” refers to a computer-implemented process whereby a selection of a text, for example, is converted into lexical tokens belonging to categories defined by a “lexer” program. In the case of natural languages, for example, those categories may include nouns, verbs, adjectives, punctuation etc. In an exemplary implementation, tokenization refers to the process by which a text is broken down into discrete units of information. Those units may be represented by symbols (e.g., numbers). Pre-tokenized may refer to text that has been converted into a stream of tokens and those tokens persisted to storage or memory and re-used, rather than the text being tokenized each time it is used.

The phrase “application programming interface” or “API” refers to a software interface by which an application program accesses operating system and/or other services.

In general, as used herein, a “claim” in a writing sample, is what the writer wants others to understand or accept, “evidence” is information that supports the writer's claim(s), and a “reason” is a statement or statements that explains how the provided evidence supports the writer's claim.

The phrase “processor” or the like refers to any one or more computer-based processing devices. A computer-based processing device is a physical component that can perform computer functionalities by executing computer-readable instructions stored in memory.

The phrase “memory” or the like refers to any one or more computer-based memory devices. A computer-based memory device is a physical component that can store computer-readable instructions that, when executed by a processor, results in the processor performing associated computer functionalities.

As used herein, a “rubric” refers to an analytic assessment and evaluation rubric used to assess and evaluate a student writing sample, for example, a written response to a provided lesson. The rubric may be arranged as a matrix, for example, with criteria listed in the matrix left column and performance levels listed across the matrix top row. Criteria identify a trait, quality, or feature to be evaluated and may include a definition and/or example to clarify the meaning of each trait being assessed. In general, as used the rubric is used as a basis for providing instructional feedback to the student, rather than merely generating a score or grade.

As used within this disclosure, a “student competency” refers to a range of expected accomplishment levels for a student, for example, based on factors such as the student's age, school grade, and past experience.

As used within this disclosure, a “lesson objective” refers to an educational purpose corresponding to a lesson. For example, the lesson objective may be one of reading comprehension, grammatical prowess, and argumentative writing skills, among others.

As used within this disclosure, a “lesson passage” refers to a text passage associated with the lesson, for example, an article used as the basis for a student text.

As used within this disclosure, a “writing prompt” refers to the prompt or question the student uses as the basis for writing the student text. The writing prompt may be a specific written scenario and/or question given to the student, for example, to guide argumentative writing. The AFS process uses this writing prompt to contextualize the student's response and the feedback.

As used within this disclosure, the “student text” or “student response” refers to a writing by the student in response to the writing prompt in reference to the lesson passage, for example, an argumentative writing sample provided by the student. Here, the student may enter the student text into a text box of a graphical user interface presenting the lesson.

As used within this disclosure, “AFS process” refers to a system and method for converting an argumentative writing sample into automated writing feedback. The AFS process involves analyzing the student's text, applying a rubric (for example, ThinkCERCA's proprietary rubric), and returning feedback on claims, evidence, and reasoning.

As used herein, the “AI Text Check App” refers to a service called to validate textual conditions (e.g., minimum length, English language detection, content appropriateness) before generating feedback.

As used herein, an “asynchronous job” refers to a background processing task queued by the back end. The asynchronous job handles computationally intensive operations (such as calling external APIs) without blocking the user interface, that is, the caller of an asynchronous job does not hold up processing while waiting for the asynchronous job to complete (or abort).

As used herein, “asynchronous worker” or “asynchronous processor” refers to a background service that processes queued evaluation jobs without blocking the main application flow, interacts with third-party APIs, and updates the evaluation's status and results once completed.

As used herein, “automated feedback” refers to feedback (comments, analysis, suggestions) generated by the AFS process, based on the student's argumentative writing sample, using ThinkCERCA's rubric. This includes guidance and ratings on the student's claim, evidence, and reasoning.

As used herein, the “Learn Platform” refers to a customer-facing application which presents lessons to students as assigned by teachers.

As used herein, the “back end” refers to a server-side component responsible for receiving requests, processing the evaluation, storing data, and coordinating asynchronous tasks. The back end is also referred to as the Learn Platform back end or the Learn Platform back end server.

As used herein, a “cancel request” refers to a user-initiated command to stop the evaluation process. Upon detection of a cancel request, the back end updates the evaluation status and removes the job from the queue.

As used herein, “claim feedback and rating” refers to an evaluation of the student's central argument (claim) regarding clarity, directness, and defensibility. The rating indicates the quality level, for example, {GOOD, NEUTRAL, NO}.

As used herein, “completion status” refers to a status indicating that feedback has been successfully generated and stored, ready to be displayed to the student.

As used herein, “error status” refers to a condition in the evaluation record indicating that the evaluation process has aborted, for example, due to missing required fields from the OpenAI response or failing preliminary checks, and that no feedback can be provided.

As used herein, an “evaluation record” refers to a database entry representing a single evaluation request. The evaluation record stores the student's text, status of the evaluation, timestamps, and feedback data (once generated).

As used herein, an “evaluation request” refers to student initiated request, for example, when a student clicks a “scan text” button in the graphical user interface. The evaluation request triggers the process of creating an evaluation record and queueing the job for generating automated feedback.

As used herein, “evaluator functions” refer to modular components within the AFS process that perform specific evaluations on the student's text. These functions may be enhanced or extended by incorporating additional evaluation algorithms, integrating different hosted models, or utilizing third-party applications to improve feedback quality and functionality.

As used herein, “evidence feedback and rating” refers to an assessment of how well the student supports their claim with relevant, credible evidence. The rating reflects the evidence's strength and relevance.

As used herein, the “front end” refers to a user-facing component of the system, typically a web-based interface where the student submits their writing and receives feedback. The front end may also be referred to as the Learn Platform front end, or the Learn Platform front end client. The front end and the back end communicate for example, using GraphQL API/HTTP: protocols.

As used herein, “Globally Unique Identifier (GUID)” refers to a unique ID generated for each evaluation request, used for tracking and retrieving the evaluation status and results.

As used herein, a “lesson passage” refers to a text passage associated with the lesson from which the student's writing prompt is derived or to which the student's response is connected.

As used herein, “OpenAI API” refers to a 3rd party large language model service that processes a received LLM prompt and returns structured feedback on the student's argumentative writing (claims, evidence, reasoning).

As used within this disclosure, “polling” refers to the practice of a first entity checks the status of a second entity to for a change in state/status of the second entity. For example, in the embodiments disclosed herein, front end occasionally or periodically checks the back end for updates on the evaluation status to determine when the evaluation is complete or when an error is reported. Likewise, the back end may poll the asynchronous processor and/or the database to determine a change in state.

As used within this disclosure, a “database” refers to a relational database used for storing evaluation records, feedback data, and other system-related information. For example, the database may be managed via the open source PostgreSQL (“Postgres”).

As used herein, a “large language model prompt” or “LLM prompt” refers to a structured input provided to a machine learning application, for example, the OpenAI API. The LLM prompt may include the student text, the writing prompt, the lesson passage, and instructions aligned with ThinkCERCA's rubric to guide the AI in generating feedback.

As used herein, a “queue” or “queue technology” refers to a message-broker service used to manage asynchronous job processing. The queue stores jobs and ensures they are executed in the background by a worker process. For example, the queue may be managed by the open-source Redis (Remote Dictionary Server).

As used herein, “reasoning feedback and rating” refers to analysis of the coherence and logical connection between the student's claim and the provided evidence. The rating indicates how effectively the student's reasoning explains or justifies the claim.

As used herein, a “Natural Language Processing Library” or “NLP library” refers to a library used to analyze text, perform sentence segmentation, and check for overlap with the Lesson Passage, for example, spaCy (or similar NLP library).

As used herein, a “student response” or “student text” refers to a writing sample submitted by the student for analysis, for example, an argumentative writing sample. The student response is an input to the AFS process.

As used herein, “System Role Instructions” refer to parameters and messages provided to an LLM (such as the OpenAI API) guiding how the LLM should generate responses and what standards the LLM should follow.

As used herein, a “taxonomy” or “writing prompt taxonomy” refers to a classification system that categorizes types of writing prompts. A taxonomy may be proprietary, and may be used to guide the automated feedback process to align with specific evaluative criteria.

As used herein, a “rubric” refers to an assessment framework used to evaluate the quality of the student's argumentative writing. The rubric focuses on key dimensions such as claim clarity, evidence selection, and reasoning quality. For example, the AFS process may use a rubric proprietary to ThinkCERCA.

The exemplary embodiments herein describe the AFS process, a system and method for transforming a student's writing sample into actionable writing feedback. The AFS PROCESS begins when a user (e.g., a student) submits their written response (“student text” or “student text response”) for feedback (“automated feedback”). The system and method evaluate the student text, generate automated feedback aligned with a rubric (for example, ThinkCERCA's proprietary rubric for evaluating argumentative writing), and return this feedback to the user, for example, via a graphical user interface presenting a lesson.

The exemplary embodiments illustrate framework-grounded automated systems that integrate expert-developed rubrics and pedagogy with scalable automation to bridge the gap between timely responses and educational rigor. The embodiments provide comprehensive, framework-grounded automated systems and methods to drive meaningful literacy development and learning outcomes. The embodiments provide feedback to students that is immediate and actionable and aligned with grade-level standards. The embodiments ease the burden of providing timely student support while maintaining high-quality feedback to facilitate skill development.

Prior related technologies include U.S. Pat. No. 11,164,474 (the '474 patent), a copy of which is incorporated by reference herein in its entirety, is entitled “Methods and systems for user-assisted composition construction” and is owned by ThinkCERCA.com, Inc., an assignee of the present application.

According to the Overview of Disclosed Embodiments section of the '474 patent, the '474 patent discloses “methods and systems for user-interface-assisted composition construction” where:
“One embodiment takes the form of a method that includes presenting, via a client-side user interface, a plurality of user-interface input fields that are initially arranged on the client-side user interface according to a predefined sequence. Each of the user-interface input fields has a respective argument-element type from among a plurality of argument-element types. The method also includes receiving textual inputs via the respective user-interface input fields, and responsively presenting corresponding argument-building-block elements via the client-side user interface according to a current arrangement on the client-side user interface of the user-interface input fields. Each presented argument-building-block element has the same argument-element type as, and includes the textual input received via, the corresponding user-interface input field. The method also includes receiving, via the client-side user interface, argument-building selections of one or more of the presented argument-building-block elements, and responsively generating a composition in a displayed text editor at least in part by populating the textual inputs into the displayed text editor according to the received argument-building selections. The method also includes submitting the generated composition for evaluation.
“Another embodiment takes the form of a client-side computing device that includes a client-device communication interface, a client-device user interface, a client-device processor, and client-device data storage containing client-device instructions executable by the client-device processor for causing the client-side computing device to carry out at least the functions listed in the preceding paragraph.”

The systems, methods, and techniques disclosed herein further enhance user-assisted composition construction and provide technical and useful functionalities beyond those disclosed in the '474 patent. The systems, methods, and techniques disclosed herein may be implemented as a stand-alone system or may be integrated into a system that includes other aspects including certain aspects of the methods and systems disclosed in the '474 patent. In any event, the systems and techniques disclosed herein represent a significant technical advance over prior systems and methods including those disclosed in the '474 patent.

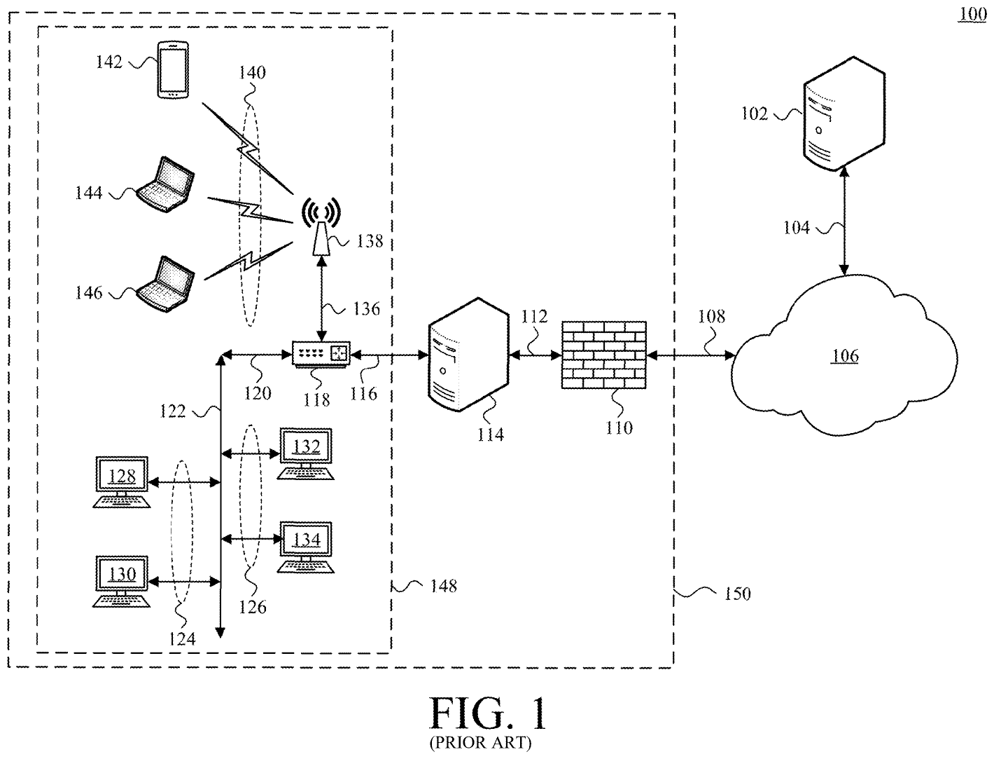

FIG. 1, which comes from the '474 patent, shows an example of a computer/communication system, for the present embodiment upon which one or more aspects of the automated feedback system disclosed herein may be implemented. As explained in the '474 patent:
“FIG. 1 depicts an example communication system that includes an example server and a number of example client-side computing devices, in accordance with at least one embodiment. In particular, FIG. 1 depicts a communication system 100 that includes a server 102, a data-communication link (i.e., link) 104, a packet-data network 106, a link 108, a firewall 110, a link 112, an NAS 114, a link 116, a router 118, a link 120, a wired local area network (LAN) 122, links 124-126, desktop computers 128-134, a link 136, a wireless access point 138, links 140, a tablet 142, laptop computers 144-146, a classroom-network zone 148, and a school-network zone 150. It should be understood that the communication system 100 is presented by way of example and not limitation, as numerous other example communication systems could be present in various different scenarios.
“The server 102 is connected by the link 104 to the packet-data network 106 . . . . The link 104, like all links discussed in this disclosure, could include one or more wired links, one or more wireless links, one or more networks, one or more access points, one or more routers, switches, bridges, computers, etc. And although certain links (e.g., the links 140) are depicted as being wireless links, it is reiterated that any one or more of the links discussed herein could be wired and/or wireless in nature. Furthermore, the packet-data network 106 may be, include, be part of, be connected to, or be independent of the global network of networks commonly known as the Internet. Entities that communicate via the packet-data network 106 may do so using Internet Protocol (IP) communication, and may be identified using IP addresses.
“As mentioned above, the communication system 100 includes the school-network zone 150 that itself includes the classroom-network zone 148. These designations are by way of example and not limitation. In the depicted example, the firewall 110 is connected to the packet-data network 106 via the link 108. The firewall 110 may act to protect entities within the school-network zone 150 from malicious and unwanted communication, among other functions. The firewall 110 is connected via the link 112 to the NAS 114, which may serve, via the firewall 110, as a point of contact to the outside world (e.g., to the packet-data network 106) for all entities within the school-network zone 150. The link 116 connects the NAS 114 with the entities that are within the classroom-network zone 148, which may represent computing and communication entities that are associated with a particular classroom, as an example. In particular, the link 116 connects the NAS 114 with the router 118. It is noted that the NAS 114 and/or another device may handle routing duties, in which case the router 118 could simply be a bridge, switch, or the like; for convenience, that device is referred to herein as the router 118.
“The router 118 is connected via the link 120 to the wired LAN 122, which in turn is connected by the links 124 with the desktop computers 128 and 130 and by the links 126 with the desktop computers 132 and 134. Each of the desktop computers 128-134 may include a typical setup having a monitor, keyboard, mouse, and the like. The router 118 is also connected via the link 136 to the wireless access point 138, which in turn is connected via the links 140 with the tablet 142 and with the laptop computers 144 and 146. It is noted that the term client-side computing device is used herein, and that each of the desktop computers 128-134, the tablet 142, and each of the laptop computers 144 and 146 are an example of a client-side computing device as that term is used in this disclosure. And there could be other types of client-side computing devices as well, such as but not limited to smartphones . . . .”

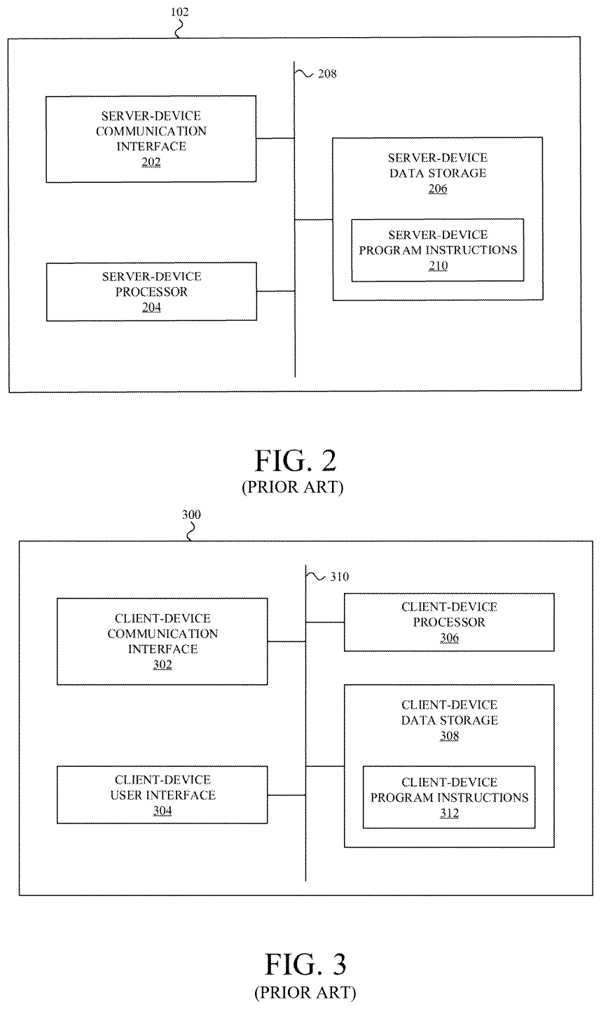

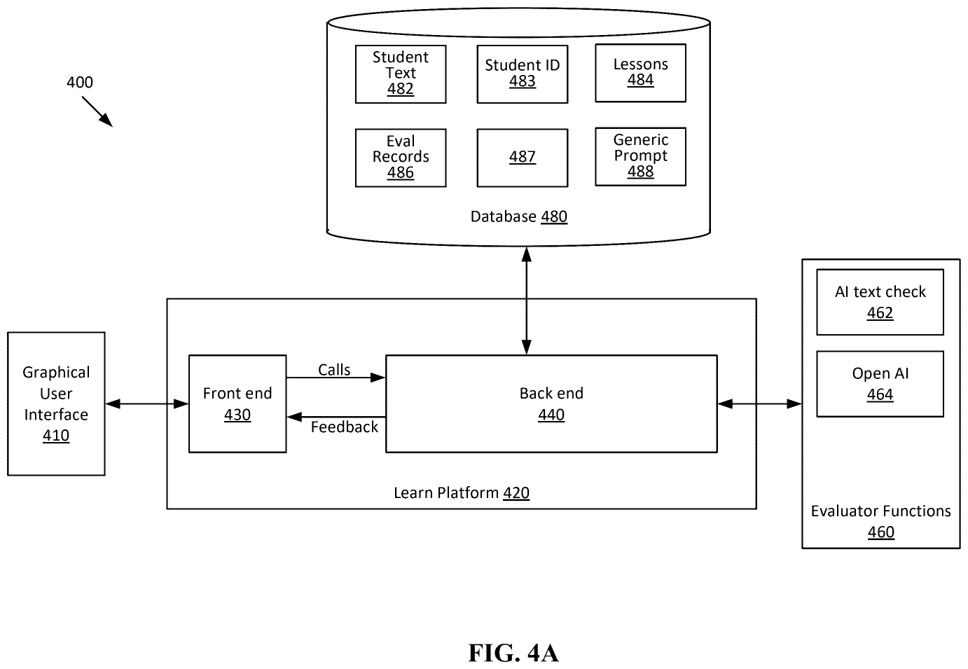

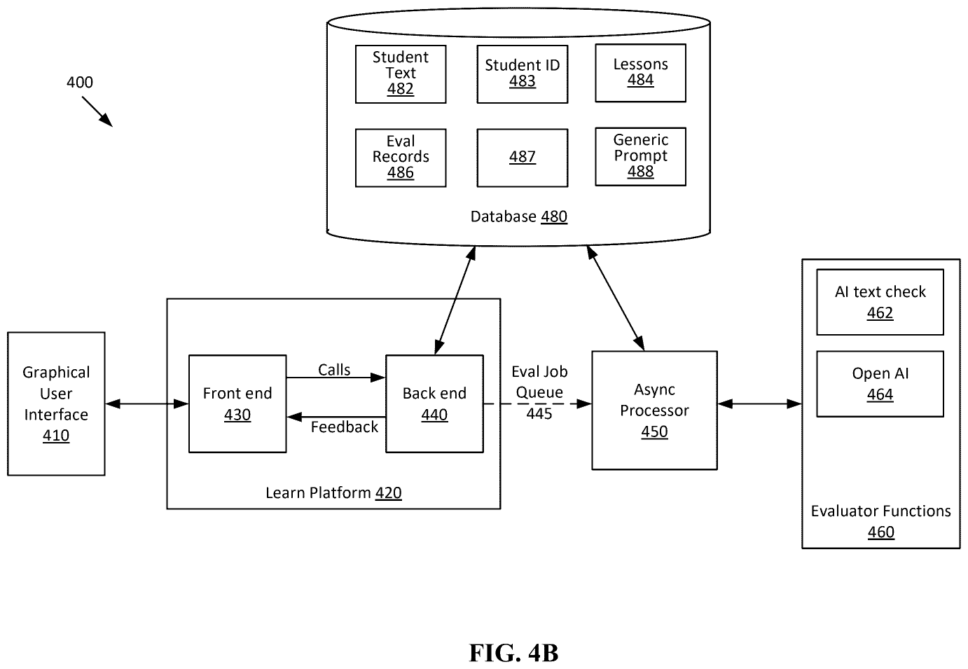

FIGS. 2 and 3 of the '474 patent depict example structures of the server of FIG. 1 and one of the client-side computing systems of FIG. 1. According to the '474 patent
“FIG. 2 depicts an example structure of the example server of FIG. 1, in accordance with at least one embodiment. As depicted in the example of FIG. 2, the server 102 includes a server-device communication interface 202, a server-device processor 204, and server-device data storage 206, all of which are communicatively connected by a server-device system bus 208. The structure of the server 102 that is presented in FIG. 2 is by way of example and not limitation, as other structures could be utilized as well or instead in different implementations. In some instances, the server 102 may also include a server-device user interface (not depicted).
“The server-device communication interface 202 may include one or more wireless-communication interfaces (for communicating according to, e.g., LTE, Wi-Fi, Bluetooth, and/or the like) and/or one or more wired-communication interfaces (for communicating according to, e.g., Ethernet, USB, and/or the like). As such, the server-device communication interface 202 may include any necessary hardware (e.g., chipsets, antennas, Ethernet cards, etc.), any necessary firmware, and any necessary software for conducting one or more forms of communication with one or more other entities as described herein.
“The server-device processor 204 may include one or more processors of any type deemed suitable by those of skill in the relevant art, some examples including a general-purpose microprocessor and a dedicated digital signal processor (DSP).
“The server-device data storage 206 may take the form of any non-transitory computer-readable medium or combination of such media, some examples including flash memory, read-only memory (ROM), and random-access memory (RAM) to name but a few, as any one or more types of non-transitory data-storage technology deemed suitable by those of skill in the relevant art could be used. The server-device data storage 206 contains server-device program instructions 210 that are executable by the server-device processor 204 for carrying out various server-side functions described herein.
“FIG. 3 depicts an example structure of an example one of the client-side computing devices of FIG. 1, in accordance with at least one embodiment. In particular, FIG. 3 depicts an example structure of a representative client-side computing device 300, which could represent the desktop computer 128, the desktop computer 130, the desktop computer 132, the desktop computer 134, the tablet 142, the laptop computer 144, the laptop computer 146, or any other client-side computing device deemed suitable by those of skill in the art for a particular implementation. As depicted in the example of FIG. 3, the client-side computing device 300 includes a client-device communication interface 302, a client-device user interface 304, a client-device processor 306, and client-device data storage 308, all of which are communicatively connected by a client-device system bus 310. The structure of the client-side computing device 300 that is presented in FIG. 3 is by way of example and not limitation, as other structures could be utilized as well or instead in various different implementations.
“The client-device communication interface 302 may include one or more wireless-communication interfaces (for communicating according to, e.g., LTE, Wi-Fi, Bluetooth, and/or the like) and/or one or more wired-communication interfaces (for communicating according to, e.g., Ethernet, USB, and/or the like). As such, the client-device communication interface 302 may include any necessary hardware (e.g., chipsets, antennas, Ethernet cards, etc.), any necessary firmware, and any necessary software for conducting one or more forms of communication with one or more other entities as described herein.
“The client-device user interface 304 may include one or more input devices (a.k.a. components and the like) and/or one or more output devices (a.k.a. components and the like). With respect to input devices, the client-device user interface 304 may include one or more touchscreens, keyboards, mice, trackpads, touchpads, other pointing devices, buttons, switches, knobs, microphones, and/or the like. With respect to output devices, the client-device user interface 304 may include one or more displays, monitors, speakers, LEDs, and/or the like. Moreover, one or more components (e.g., an interactive touchscreen-and-display component) of the client-device user interface 304 could provide both user-input and user-output functionality. And certainly, other user-interface components could be used in various different contexts.
“The client-device processor 306 may include one or more processors of any type deemed suitable by those of skill in the relevant art, some examples including a general-purpose microprocessor and a dedicated DSP.
“The client-device data storage 308 may take the form of any non-transitory computer-readable medium or combination of such media, some examples including flash memory, ROM, and RAM to name but a few, as any one or more types of non-transitory data-storage technology deemed suitable by those of skill in the relevant art could be used.
“The client-device data storage 308 contains client-device program instructions 312 that are executable by the client-device processor 306 for carrying out various client-side functions described herein, including but not limited to the method 400 of FIG. 4.”

Under the exemplary embodiments described herein, a student participates in an AFS-enabled lesson, which, for example, may involve on or more of a lesson passage, a writing prompt, a rubric, a vocabulary list, an image, and/or audio and video components. In response, the student drafts an argument (as described in the '474 patent). The Automated Feedback System (AFS) is a machine learning based system that attempts to simulate the kind of revision-oriented feedback that a student completing a writing lesson in the ThinkCERCA platform could expect to see from a teacher or teaching assistant who is evaluating the student's writing with the ThinkCERCA rubric for the lesson and is trained in ThinkCERCA's “System of Teaching Writing” (STWM). The STW provides the person or system evaluating the writing with “feedback stems” from which specific, directed feedback can be created for the student. The intent of this feedback is to direct the student towards revision of their response to the lesson, so that the revised response would eventually score at higher mastery levels across the ThinkCERCA rubric.

The student writes a response to the lesson's writing prompt by entering the text of their response into an input box in the Learning Platform (LP) front end. During this drafting process, the platform may provide optional (button-activated) machine learning backed spelling and grammar assistance for the student's writing. These technologies are integrated into the LP front end as provided by third parties.

The student submits the response text for evaluation, for example, by clicking a GUI presented button labeled “Scan,” initiating an API call to the LP back end with a context for the writing evaluations which may include:
String representations of the lesson readings and other lesson textual materials, including vocabulary lists and transcripts of audio and video lesson components,
a string representation of the lesson writing prompt,
string representations of the ThinkCERCA rubric categories for the lesson, and
a string representation of the student response.

The AFS evaluates a student's written responses to ThinkCERCA lessons in several phases backed by machine learning methods:
1. During the reading of selected passages belonging to the lesson, the ThinkCERCA platform provides AI-backed assistive technologies such as simplified text display for impaired readers, dictionary lookups (verbal and pictorial), machine-generated text to speech, and machine-generated translation of the reading texts to multiple human languages. These technologies are integrated into the AFS as provided by third parties. In one exemplary implementation, the assistive technologies may include Microsoft's Azure Immersive Reader product (https://azure.microsoft.com/en-us/products/ai-services/ai-immersive-reader/).
2. During the drafting of written responses for the lesson, the ThinkCERCA platform provides machine learning backed spelling and grammar assistance as the student is writing. These technologies are integrated into the AFS as provided by third parties. In one exemplary implementation, this includes WProofreader SDK from WebSpellChecker.com (https://webspellchecker.com/wsc-proofreader/).
3. At multiple points during the drafting process, the student can submit the response for evaluation by ThinkCERCA's machine learning driven evaluator functions. These functions, which are developed specifically by ThinkCERCA, include:
   a. Natural Language Processing (NLP) algorithms that help assure that the student response is written in English and is not random data or data intended to “break” the AFS and is substantial enough to be passed on to more expensive functions for further analysis. The NLP algorithms may be commodity software libraries, for example, open source in nature. They do not make remote calls to services provided by third parties (unlike the assistive and spelling check integrations).
   b. Sentence similarity algorithms that compare passages in the student response to passages in the lesson readings, as an attempt to both identify bulk plagiarism from the lesson passages, as well as identify potential citations made by the student in the response that refer to the readings. The above-described sentence similarity algorithms may be commodity software libraries, for example, open source in nature. They do not make remote calls to services provided by third parties (unlike the assistive and spelling check integrations).
   c. For a subset of lessons, the individual sentences of the student response may be evaluated against machine learning models that have been trained on a corpus of pre-evaluated texts, for the purpose of comparing those sentences to exemplars of claim, evidence, reasoning and other CERCA concerns, or to compare the response against previous responses that scored at particular levels on the ThinkCERCA rubric. In an exemplary embodiment, Claim/Counterclaim, Evidence, Reasoning, Coherence, and Audience—the pillars of the CERCA framework for teaching argumentative writing-might be the CERCA concerns.
   d. Finally, the student response may be evaluated by fine-tuned LLMs with one or more structured “LLM prompts” that direct the LLM to perform specific evaluations of the response that correspond to rubric categories and mastery levels, as described herein, and to provide feedback to the student according to the forms and precepts of the STW.

In an exemplary implementation, the NLP algorithms and/or the sentence similarity algorithms may be commodity software libraries, usually open source in nature, which are included in the source code for the application. In a typical implementation, these do not make remote calls to services provided by third parties (unlike the assistive and spelling check integrations).

The AFS attempts to provide its feedback in near real time, so that the students can go through multiple rounds of revision and renewed feedback.

The AFS receives a lesson passage, a writing prompt, and student text as inputs, and returns a claim feedback and rating, an evidence feedback and rating, and a reasoning feedback and rating. The AFS inputs may be formatted as:
1. String representations of the lesson readings and other lesson textual materials, including vocabulary lists and transcripts of audio and video lesson components,
2. A string representation of the lesson writing prompt,
3. String representations of the ThinkCERCA rubric categories for the lesson, and
4. A string representation of the student response.

FIG. 4A is a system block diagram of the AFS 400 under a first exemplary embodiment. The AFS system 400 includes a graphical user interface (GUI) 410, a learn platform 420, a learn platform database 480, and a plurality of evaluator functions 460. The learn platform 420 is broadly divided into a front end 430 that interfaces with the GUI 410 and a back end 440 that interfaces with the database 480. The back end 440 manages tasks for the evaluator functions 460. The learn platform 420 may be an application hosted on a single device (server), or may be distributed amongst two or more devices. The back end 440 may access the database 480 to provide data for calls to the evaluator functions 460. The back end 440 receives data returned from the evaluator functions 460 in response to the evaluator function calls and processes the received data for storage in the evaluation record 486 in the database 480. The back end 440 may update state variables in the evaluation record 486 to indicate the changes made to the evaluation record 486. When a state change in the evaluation record 486 indicates the response from the evaluator functions are finished, the back end 440 processes the data in the evaluation record 486 to provide evaluation feedback to the front end 430. The front end 430 presents the evaluation feedback to the user via the GUI 410. The AFS 400 is described in further detail below.

FIG. 4B is a system block diagram of the AFS 400 under a second exemplary embodiment. The AFS system 400 includes a graphical user interface (GUI) 410, a learn platform 420, a learn platform database 480, an asynchronous processor 450, and a plurality of evaluator functions 460. The learn platform 420 is broadly divided into a front end 430 that interfaces with the GUI 410 and a back end 440 that interfaces with the database 480 and the asynchronous processor 450. The back end 440 enqueues evaluation jobs for the asynchronous processor 450. The asynchronous processor 450 receives the enqueued evaluation jobs and manages tasks for the evaluator functions 460. The asynchronous processor 450 may access the database 480 to provide data for calls to the evaluator functions 460. The asynchronous processor 450 receives data returned from the evaluator functions 460 in response to the evaluator function calls and processes the received data for storage in the evaluation record 486 in the database 480. The asynchronous processor 450 may update state variables in the evaluation record 486 to indicate the changes made to the evaluation record 486. The back end 440 polls the evaluation record 486 to check the state variables. When the back end 440 detects a state change in the evaluation record 486, the back end 440 processes the data in the evaluation record 486 to provide as evaluation feedback to the front end 430. The front end 430 presents the evaluation feedback to the user via the GUI 410. The AFS 400 is described in further detail below.

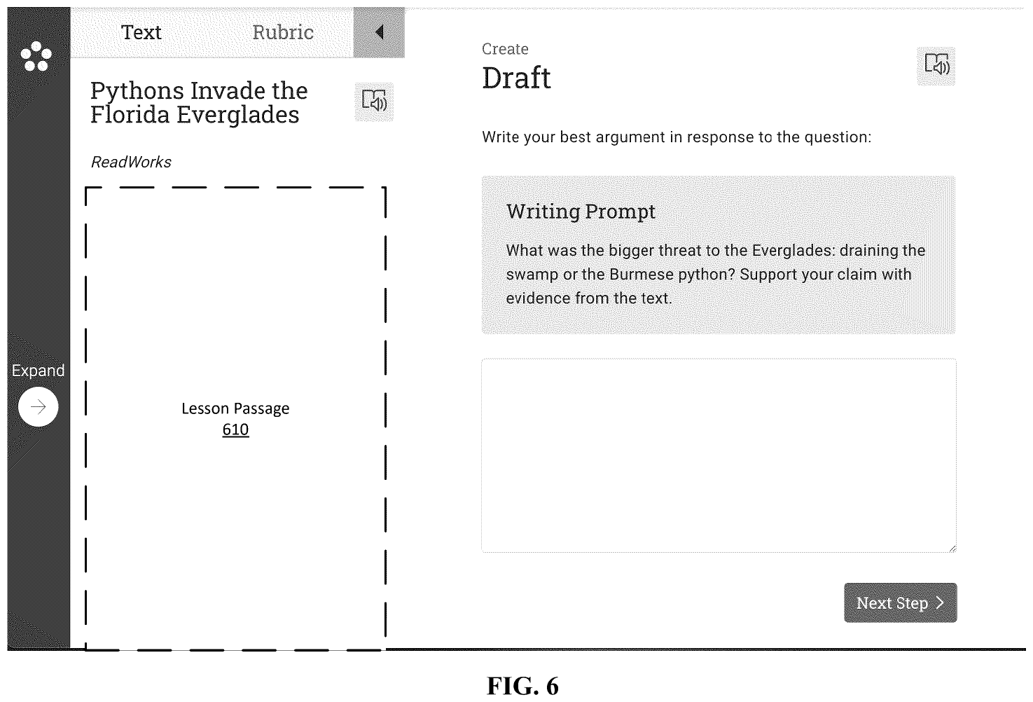

For both the first and second embodiments, the users (for example, teachers and students) interact with the AFS via the GUI 410. The GUI 410 presents lessons 484 to users and receives text input from the users, for example via text boxes (see FIGS. 6-9). Upon initiation by the user, the GUI 410 provides student text 482 to a front end 430 of a learn platform 420 via an evaluation request. The front end 430 receives the evaluation request from the GUI 410 and forwards the student text and evaluation request to a learn system back end 440. The back end 440, stores the student text 482 in a learn platform database 480 and initializes an evaluation record 486 in the database 480. The evaluation record contains the student text and the evaluation request. The back end assigns a global user identifier (GUID) to the evaluation record 486. A student ID record 483 is updated to reference the evaluation record 486 and the student text 482. The student ID record stores metadata for the student, for example the student's grade level, a record of lessons completed by the student, and/or the lesson results.

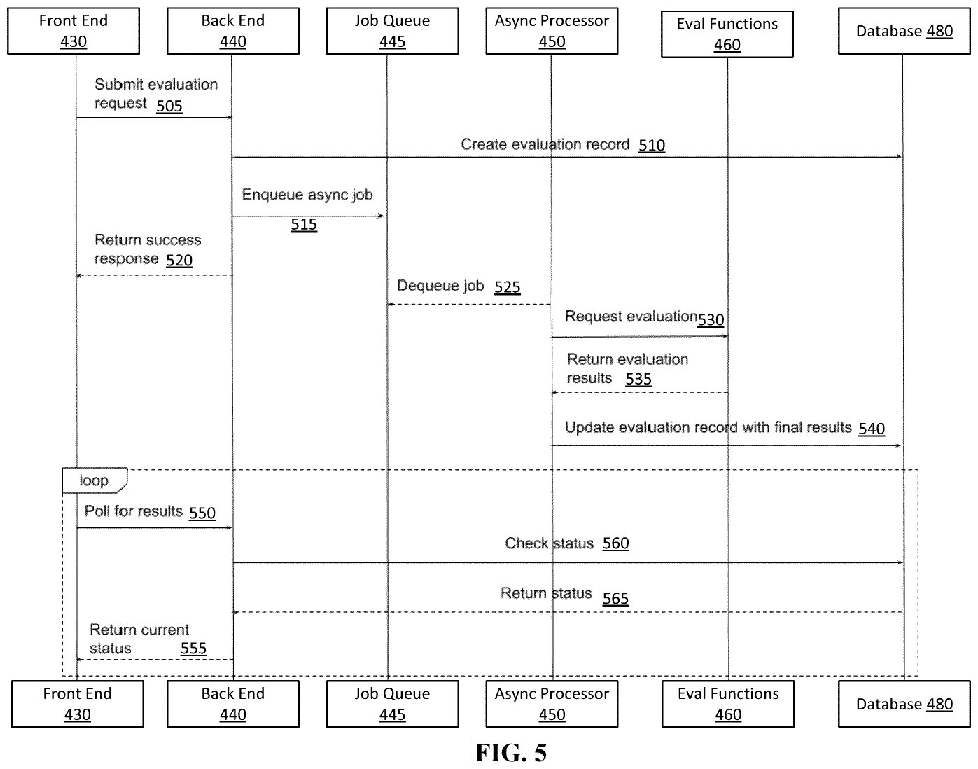

The following describes an exemplary embodiment for a method for automatically providing feedback in the context of the system embodiments of FIG. 4B, with reference to the flow diagram of FIG. 5 in view of an example illustrating how the AFS system operates on a specific set of inputs—namely, a particular lesson passage, a writing prompt, and a student's argumentative writing sample—to produce actionable automated writing feedback. This example demonstrates how the system transforms a raw student response into structured claim, evidence, and reasoning feedback.

For this example, a teacher prepares and assigns a lesson about the environmental challenges facing the Florida Everglades. For each lesson, a student assignment record is created for each student in that class. The resulting student assignment id is available to the front end 430 for each student login. The lesson includes a passage detailing the historical drainage of the wetlands, subsequent reclamation and conservation efforts, and a new threat posed by the invasive Burmese python. The writing prompt asks the student to determine which posed a bigger threat: the drainage activities or the Burmese pythons, and to support that claim with evidence from the text, as shown by table 1:

TABLE 1

| | |
|---|---|
| Lesson Passage | A detailed text describing the Florida Everglades, how it was |
| | drained over time for agricultural and urban development, |
| | subsequent conservation efforts, and the threat introduced by |
| | Burmese pythons |
| Writing Prompt | “What was the bigger threat to the Everglades: draining the swamp |
| | or the Burmese python? Support your claim with evidence from the |
| | text.” |
| Student Text | The bigger threat to the Everglades was the |
| | Burmese python. The Burmese python was a bigger |
| | threat to the Everglades for many reasons. First, |
| | The first python was found in Floridian in 1979, |
| | at first the python was only known as a pet but |
| | then suddenly released by its owner. Reason why it |
| | was a problem to the everglades was because in |
| | 1922 numerous Burmese pythons escaped pet stores |
| | and cages which damaged in hurricane Andrew, now |
| | because of that numbers have started to grow at a |
| | faster rate. Second, The Burmese pythons have been |
| | released in southern Floridian and found a new |
| | habitat which was the everglades. Well, they |
| | pythons are eating machines they could eat |
| | anything for example deer, bobcat, and also up to |
| | alligators. they also did enjoy dinning on small |
| | mammals and also birds. That wasn't good since |
| | that the small mammals have went down |
| | significantly, also in other areas small mammals |
| | have now decreased since the python has not |
| | established itself there in those areas. I know |
| | some people may not agree with my opinion and yes |
| | there is also another problem that the Everglades |
| | have faced, example they had to dig out canals |
| | which was because they either wanted to remove it |
| | or redirect the waster flow-age, another example |
| | 50% of it have been reclaimed as agricultural use |
| | or urban use I understand that it is also a harm |
| | to the everglades but the pythons have made |
| | mammals decrease and also have damaged hurricane |
| | Andrew. unlike in other places it has not been |
| | affected since they python have not made it or |
| | discovered different areas besides the everglades. |
| | In conclusion, In my opinion the pythons were a |
| | big threat to the everglades yes others might not |
| | agree but it has decreased our mammals because of |
| | it and has damaged hurricane Andrew, it has also |
| | gotten to the point where they had to send people |
| | to go hunt down these snakes in order for the |
| | population of mammals or etc. to not go down any |
| | further. That is why i think that the Burmese |
| | pythons were a big threat to the everglades. |

After typing their response into the GUI 410, the student requests evaluation, for example, by selecting a “Scan Text” button presented by the GUI 410. The front end 430 sends an evaluation request to the back end 440, including the student text (Table 1) and a lesson identifier (ID), for example, a unique identifier for this specific Everglades lesson (see FIG. 5 505). For example, the front end 430 and back end 440 may communicate via GrapQL API/HTTP. The back end 440 may use relational queries to the database 480 to collect the most recent updated value of student text, the lesson passage, the writing prompt, and the student's grade level.

Upon receiving the evaluation request, the back end 440 acknowledges receipt of the evaluation request 520 (FIG. 5) to the front end 430 and creates an evaluation record 486 in the database 480 representing the request 510 (FIG. 5). The evaluation record 486 includes links (associated IDs) to access the student text 482 and the lesson 484. A Globally Unique Identifier (GUID) is generated and associated with the evaluation record 486 for tracking. A status field in the evaluation record 486 is initialized to “waiting_evaluation.”

The back end 440 enqueues a job to the asynchronous processor 450 with metadata for the asynchronous processor 450 to access the evaluation record 486 in the database 480. The back end 440 returns control to the front end 430 immediately, indicating that processing of the evaluation request has started.

Subsequent handling of the evaluation request is managed by the asynchronous processor 450. The asynchronous processor updates a job status field in the evaluation record 486. The front end 430 polls the back end 440 (for example, every 1-3 seconds), and the back end 440 responds to the poll by checking the job status field in the evaluation record 486. The job status field of the evaluation record 486 is status is initialized as “waiting_evaluation,” and is updated by the asynchronous processor 450 as the evaluator functions report their respective progress. The back end 440 conveys the current status to the front end 430, and the front end displays the current status to the student via the GUI 410. For example, GUI 410 displays a status of “Processing . . . ” until the feedback in response to the submitted student text 482 is available.

The student may optionally cancel the evaluation request via the GUI 410. Here, the back end 440 marks the evaluation record as canceled and removes the job from the queue. For this example, the process continues uninterrupted.

The asynchronous processor 450 receives a queued job and parcels out evaluation tasks to the evaluation functions 460. For example, the evaluation functions may include calls to an AI text check 462 to ensure the student text 482 meets a list of criteria for further processing, and an Open AI function 464 seeking evaluation of the student text by a trained LLM, for example, Chat GPT. The asynchronous processor 450 dequeues the queued job 525 (FIG. 5) and uses the GUID to retrieve all relevant information from the database 480, for example, the student text 482, and lesson data 484, for example, the lesson passage, writing prompt, rubric instructions, and the like. These data points are prepared as variables for an LLM prompt for the open AI evaluation function 464.

Before calling the LLM, the asynchronous processor 450 calls the AI text check evaluator function 462 to perform text validations. This evaluation, for example, checks character length, a sentence count threshold, foreign language detection, overlap with lesson passage (no excessive copying beyond allowed threshold), and/or presence of disallowed content or code. If the checks do not pass, the evaluation is aborted. Otherwise, the asynchronous processor updates the status flag in the database 480 evaluation record 486 to indicate all the checks have passed.

Upon passing the preliminary checks, the asynchronous processor 450 constructs an LLM prompt for the LLM (Open AI 464), as per the Open AI prompt API. The LLM prompt may include, for example, the student text 483, the lesson passage, the writing prompt, the rubric, and detailed instructions. The detailed instructions may be based on the lesson rubric. The following are examples of detailed instructions:
1. “Identify claim, evidence, and reasoning from the student's text.”
2. “Evaluate each against ThinkCERCA's argumentative writing rubric.”
3. “Return claim_sentence, claim_rating, claim_feedback, evidence_sentence, evidence_rating, evidence_feedback, reasoning_sentence, reasoning_rating, reasoning_feedback.”

The asynchronous processor 450 sends the LLM prompt to the OpenAI API in an evaluation request 530. Upon completing the evaluation, the OpenAI evaluation function 464 returns a structured response to the asynchronous processor 535. Table 2 shows an exemplary prompt response from the Open AI evaluator function 464.

TABLE 2

| | |
|---|---|
| claim_sentence | The bigger threat to the Everglades was |
| | the Burmese python. |
| claim_rating | GOOD |
| claim_feedback | Your claim is clear and directly |
| | addresses the writing prompt's question. |
| evidence_sentence | They can eat anything from deer to |
| | bobcats, raccoons, and even alligators, |
| | leading to a significant decrease in |
| | small mammal populations. |
| evidence_rating | GOOD |
| evidence_feedback | You provide relevant evidence describing |
| | the invasive species' dietary impact and |
| | the resulting decline in certain animal |
| | populations., |
| reasoning_sentence | Since Burmese pythons prey on a wide |
| | range of Everglades wildlife, their |
| | presence disrupts the natural ecosystem |
| | more directly than drainage, thus posing |
| | a greater threat. |
| reasoning_rating | NEUTRAL |
| reasoning_feedback | Your reasoning attempts to connect the |
| | evidence to the claim but could be more |
| | explicit in explaining why this impact is |
| | more harmful than the historical |
| | drainage. |

The asynchronous processor 450 confirms the required fields in the Open AI 464 response are present and valid, updates the evaluation record 486 in the database 480 with the returned feedback, ratings, and timestamps, and sets the evaluation status to completed 540. It checks that the Open AI 464 response has all the requested fields on the response. If Open AI 464 has not provided a response for all functions, the asynchronous processor updates the evaluation record 486 in the database 480 an error status, which is eventually reported to the student via the GUI 410.

After the front end 430 receives confirmation that the evaluation requests was successfully submitted, the front end 430 periodically polls the back end 430 for results 550. The back end 440 responds to this poll by checking the status field of the evaluation record 486 in the database 480, as shown by 560, 565. The back end 440 returns the current status 555 to the front end 430.

When the front end polling receives notice that the evaluation record status field has been set to completed, the back end 440 fetches the stored feedback and provides this feedback to the front end 430. The front end updates the GUI 430 to display the feedback, for example, in the context of the student text, as shown by table 3.

TABLE 3
Feedback presented to student

| Feedback | Feedback | |
|---|---|---|
| Subject | Rating | Written Feedback |
| Claim | GOOD | Your claim is clear and directly addresses the |
| | | writing prompt's question.” |
| Evidence | GOOD | You provide relevant evidence describing the |
| | | invasive species' dietary impact and the resulting |
| | | decline in certain animal populations |
| Reasoning | NEUTRAL | Your reasoning attempts to connect the evidence |
| | | to the claim but could be more explicit in explaining |
| | | why this impact is more harmful than the historical |
| | | drainage.” |

For this example, the feedback rating titles presented to the student are determined by the rating (e.g., “NEUTRAL,” “GOOD”) provided by OpenAI in the evaluation record for each feedback type (claim, evidence, reasoning). These titles are mapped to specific ratings. There may be multiple pre-written options for each rating per written feedback type, where one of these is selected randomly to add variation.

The body of the feedback cards is directly pulled from OpenAI's response, specifically the claim_feedback, evidence_feedback, or reasoning_feedback fields. This content is displayed exactly as provided in the OpenAI response. This approach ensures the feedback is both relevant and consistent with OpenAI's evaluation while allowing for some flexibility and variation in the presentation of card titles.

This example demonstrates how the AFS process handles a real-world scenario. Starting from the student submitting their writing sample, the system validates the input, constructs an LLM prompt, and, after receiving the LLM's structured analysis, returns clear, actionable feedback. The final output helps the student understand the strengths and weaknesses of their argumentative writing, thus fulfilling the purpose of the invention.

Note: while the description of the second embodiment describes the asynchronous processor 450 interacting with the evaluator functions 460, in the first embodiment (and/or alternative embodiments), the evaluator functions 460 may be managed by the back end 440 instead of the asynchronous processor 450.

Evaluator functions 460 may be created to compare student responses against exemplars. For example:
1. A target lesson and grade level band is chosen to be developed for automated feedback.
2. Teaching materials (readings, vocabulary lists, LLM prompt(s) for the writing response to be evaluated) are collected for the target lesson.
3. A pool of final, submitted and human-evaluated responses are collected to train models, for example 600-1000 responses.
4. A “labeling guide” is developed that informs the labeling workforce on the criteria for labeling sentences in the student responses. Generally, a broad selection of responses across various performance levels, lengths and complexity are preferable. Responses may be used to build models that identify features identified by human scorers, including claim, evidence, and reasoning.
5. Student response sentences are labeled according to the criteria in the guide. Annotation may be at the sentence or phrase level and identifies features being captured.
6. The labeled data is collated into a dataset suitable for training machine learning (ML) models.
7. ML are trained models using the collated data set to classify sentences according to their contribution to the features defined as part of the human evaluation, and which, for argumentative writing, will include “claim,” “evidence,” and “reasoning.” The specific ML modeling technique will vary, as will the choice of algorithms, parameters, embedding contexts and other factors, depending on what works well and what conforms to industry standard or state of the art practice for bias-free natural language processing/natural language understanding (NLP/NLU) at the time of training.
8. The models are evaluated, for example using industry-standard best practices, such as testing the models on a separate set of “holdout” records from the original dataset. The human-labeled responses are compared to the model-labeled responses, through the use of standard and custom metrics, such as “precision,” “accuracy,” and “recall.”
9. The model training may be tuned to optimize performance.
10. Model performance may be further augmented by combining the model predictions with the outcomes of heuristic methods of feature identification (such as sentence similarity and keyword matching) to attain the best possible results, or at least practically effective results.

FIG. 6 is an example of a screenshot that may appear at a display screen of a client device. The illustrated screenshot includes a left side and a right side. The left side has options to choose between “Text” and “Rubric.” The Text selection displays a lesson passage 610 (textual information, e.g., an article for a student to read), which in the illustrated example is an article entitled “Pythons Invade the Florida Everglades” (the text has been masked in the view). Selecting the Rubric instead would display information about the associated rubric. The right side of the screen includes a “Writing Prompt,” which, in the illustrated implementation, relates to the Everglades article. Specifically, the “Writing Prompt” in the illustrated example asks, “What was the bigger threat to the Everglades: draining the samp or the Burmese python?” This is a writing prompt to which the student is expected to respond. The screenshot provides a text field below the writing prompt where the student can enter his or her response.

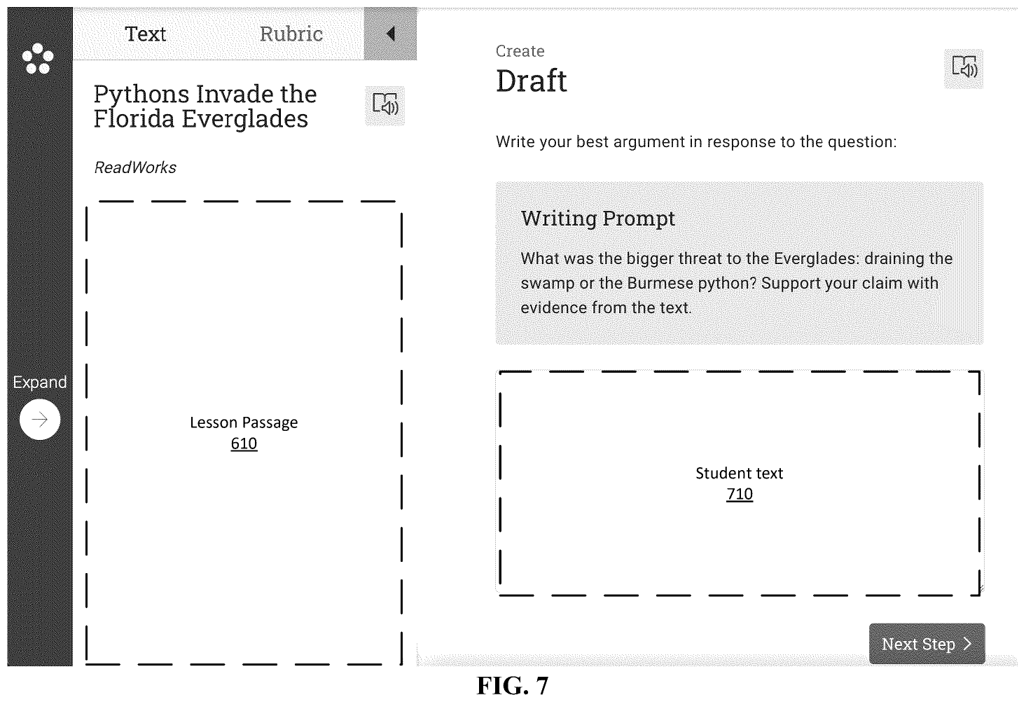

FIG. 7 is a second screen shot showing a similar view to FIG. 6. However, here student text 710, a response to the writing prompt may be entered into the student text field 710 in the screenshot of FIG. 7. The content of the student text 710 is not displayed in this drawing. Specifically, the response provided is expected to be (and is assessed by the computer as if it is) a response to the “Writing Prompt” that appears on the screenshot above the text field. Once the response has been entered into the student text field 710 and the student is satisfied with, and wants automated feedback on the response, the student may selects the “Next Step >” button. This causes the automated feedback system disclosed herein to perform processes in accordance with the disclosure herein, whereby the text of the response is analyzed, and feedback is provided. Notably, the system does not submit the response to a teacher or other reviewer in response to the student selecting the “Next Step >” button.

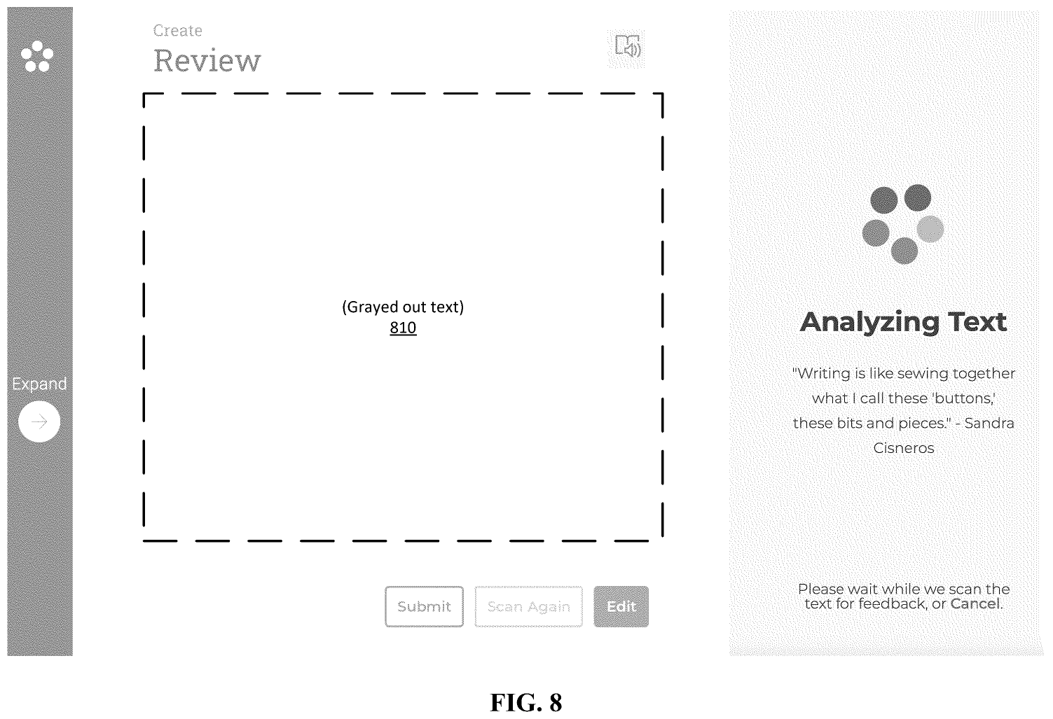

FIG. 8 shows an example of a screenshot that may appear at the display screen of the client device after the student selects the “Next Step >” button on the screen of FIG. 7. The screenshot in FIG. 8 includes a graphical and textual element, on the right side of the screen, indicating that the Automated Feedback System (AFS) is analyzing the text of the prompt response that was entered into the text field in FIG. 7. Here, the text of the response in the illustrated example is covered with a box 810 indicating the text has been grayed out), but, in an actual implementation, the text would be visible and readable (and not covered), for example with a grayed font.

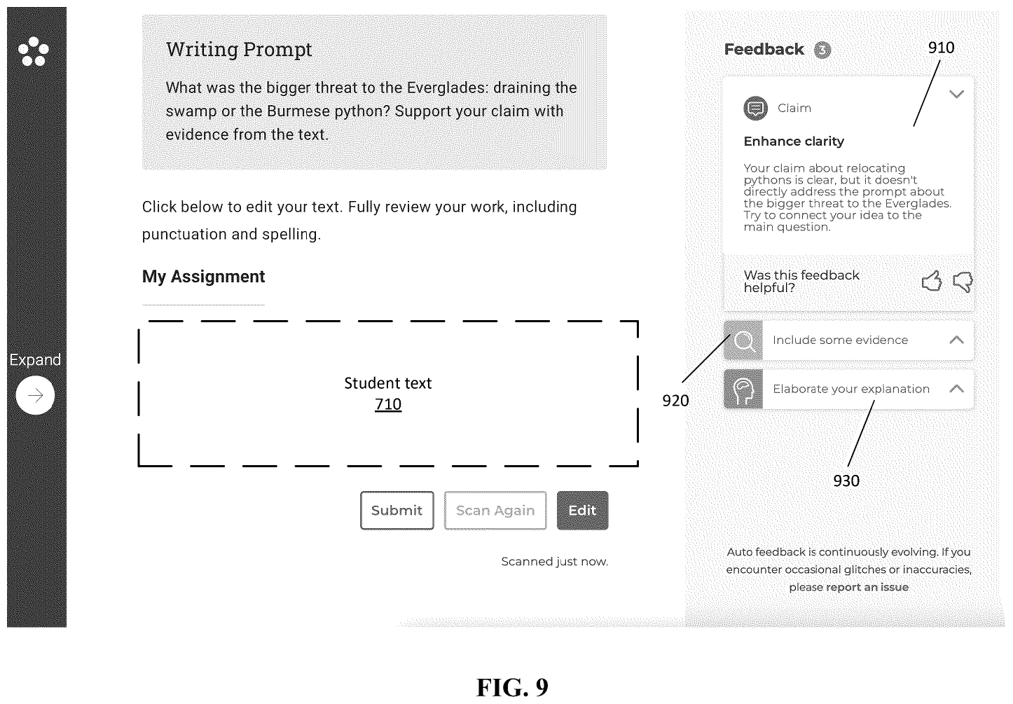

FIG. 9 shows an example of a screenshot that may appear at the display screen of the client device after the AFS has finished analyzing the text of the LLM prompt response. Here, the right hand portion of the screen displays feedback including a general comment 910, and suggestion flags to include supporting evidence 920 and to elaborate the explanation 930. It is important to emphasize that the AFS alone applies these flags without any input from the student. Thus, the AFS is able to (and does) automatically identify different portions of a student's written prompt response as either a claim, evidence, or reasoning, completely from a computer-based assessment of the LLM response prompt without any input from the student about what might be a claim, evidence, or reasoning.

From this categorization, the AFS provides feedback on and suggested revisions to the student's response on the right side of the screenshot. Any feedback or suggested revisions are tailored to be actionable, specific, and focused and to help the student grow and improve in his or her writing. Examples of feedback or suggested revisions that may be provided to a student, automatically by the AFS.

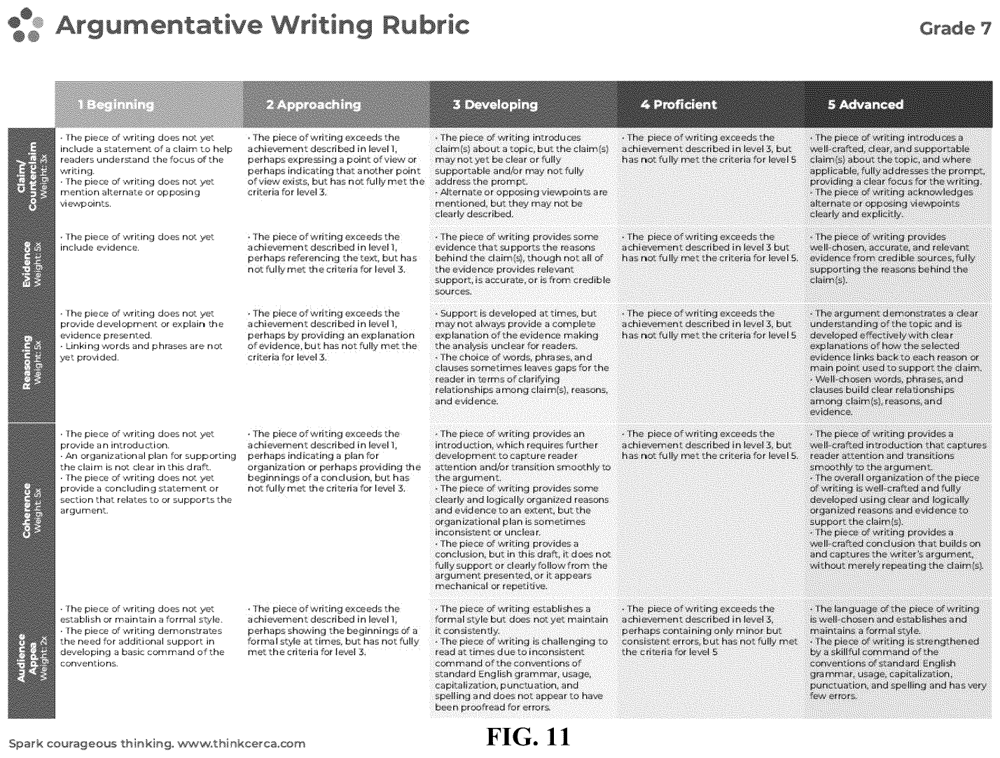

FIG. 11 is a table representing an example of a rubric that relates to argumentative writing. The “rubric” in the illustrated example, shows a set of evaluation criteria and mastery levels that a teacher (or here, the system) may use to grade a student response. The rubric may be stored in computer memory and accessed by the AFS in assessing a student's response.

A number of embodiments of the invention have been described. Nevertheless, it will be understood that various modifications may be made without departing from the spirit and scope of the invention.

In various implementations, certain computer components disclosed herein can be implemented by one or more computer-based processors (referred to collectively herein as the processor) executing computer-readable instructions stored on non-transitory computer-readable medium to perform corresponding computer-based functionalities. The one or more computer-based processors may be virtually any kind of computer-based processors and can be contained in one housing or distributed across a network and can be at one or more physical locations, and the non-transitory computer-readable medium can be or include any one or more of a variety of different computer-based hardware memory/storage devices either contained in one housing or distributed across a network and can be at one or more different locations.

Certain functionalities are described herein as being accessible or activated by a user selecting an onscreen element (e.g., a button or the like). This should be construed broadly to include any kind of visible, user-selectable element or other user interactive element.

The systems and techniques disclosed herein can be implemented in a number of different ways. In one exemplary implementation, the systems and techniques disclosed herein may be incorporated into an existing computer program. In various implementations, the systems and techniques can be deployed otherwise.

The systems and techniques disclosed herein may be implemented using a variety of specific software packages and/or configurations operating within a computer-based environment. Certain implementations may include spaCy's parsing to split sentences. Certain implementations may use “langdetect” (https://pypi.org/project/langdetect/) or FastText (https://fasttext.cc/docs/en/language-identification.html) for detecting English. In some implementations, anything that is not determined to be English may be deemed unusable for the application, ergo, as good as stray characters. To identify potential citations, certain implementations may use the sentence_transformers library from Hugging Face, particularly the ‘bert-base-nli-mean-tokens’ and ‘paraphrase-MiniLM-L3-v2’ models. The former is trained for Natural Language Inference, essential for understanding relationships between sentences, while the latter excels in paraphrasing tasks. For detecting bulk plagiarism, certain implementations may use ‘word2vec-google-news-300’, chosen for its proven effectiveness in our tests.

It should be understood that the example embodiments described herein may be implemented in many different ways. In some instances, the various methods and machines described herein may each be implemented by a physical, virtual, or hybrid general purpose computer, such as a computer system, or a computer network environment, such as those described herein. The computer/system may be transformed into the machines that execute the methods described herein, for example, by loading software instructions into either memory or non-volatile storage for execution by the CPU. One of ordinary skill in the art should understand that the computer/system and its various components may be configured to carry out any embodiments or combination of embodiments of the present invention described herein. Further, the system may implement the various embodiments described herein utilizing any combination of hardware, software, and firmware modules operatively coupled, internally, or externally, to or incorporated into the computer/system.

To summarize, after the evaluation record has been created, under the first and second embodiments the AFS calls the following evaluator functions to generate writing feedback:
NLP text-check algorithms to validate the response as a candidate for feedback and break text into sentences.
Sentence similarity algorithms that compare passages in the student response to the lesson readings to identify potential plagiarism.
For a subset of lessons, the text may be sent to the sentence evaluation model, for example, trained to identify specified concerns
An LLM prompt is constructed from the AFS inputs (and optionally the output of the sentence evaluation model) and calls a third-party provided LLM to perform specific evaluations of the response that correspond to rubric categories and mastery levels, as described herein, and to provide feedback to the student according to the forms and precepts of the STW.
   The evaluation record is updated with the results of the evaluation process. The AFS produces as its outputs:
1. A series of pieces of feedback that may be grouped into specific types or categories displayed to the student in the drafting process.
2. Specific sentences from the student response may be highlighted in the LP front end display and optionally associated with pieces of feedback.

Under the exemplary embodiments, the AFS evaluates a student's written responses to ThinkCERCA lessons in several phases backed by machine learning methods. For example, when presenting selected lesson passages, the ThinkCERCA platform provides AI-backed assistive technologies such as simplified text display for impaired readers, dictionary lookups (verbal and pictorial), machine-generated text to speech, and machine-generated translation of the reading texts to multiple human languages. These technologies may be integrated into the AFS as provided by third parties. In one exemplary implementation, the assistive technologies may include Microsoft's Azure Immersive Reader product (https://azure.microsoft.com/en-us/products/aiservices/ai-immersive-reader/).

While the student drafts written responses for the lesson, the ThinkCERCA platform provides machine learning backed spelling and grammar assistance as the student is writing. These technologies are integrated into the AFS as provided by third parties. In one exemplary implementation, this may incorporate the Sapling AI Grammar Checker API from Sapling.ai (https://sapling.ai/grammar-check).

At multiple points during the drafting process, the student may submit the response for evaluation by ThinkCERCA's machine learning driven evaluator functions. These functions may include:
a. NLP text-check algorithms to confirm that the student response is written in English, is not random data or data intended to “break” the AFS, and is substantial enough to be passed on to more expensive functions for further analysis.
   i. These functions may be hosted as a single service on AWS as an API endpoint and implemented in a straightforward manner using Python and Spacy. The service receives the student text, runs the checks one after the other, and returns the results.
      1. If all tests as passed, the text is sent to the next phase (b)
      2. If any of the tests fail, an informative error message is returned to the student based on the nature of the failure (i.e., which test failed).
   ii. The functions do not make remote calls to services provided by third parties.
b. Sentence similarity algorithms compare passages in the student response to passages in the lesson readings, as an attempt to both identify bulk plagiarism from the lesson passages.
   i. The above-described sentence similarity algorithms may be, for example, commodity software libraries, usually open source in nature. They do not make remote calls to services provided by third parties (unlike the assistive and spelling check integrations).
c. For at least subset of student responses, the individual sentences of the response may be evaluated against machine learning models that have been trained on a corpus of pre-evaluated student essay texts, for the purpose of comparing those sentences to exemplars of claim, evidence, reasoning and other concerns, or to compare the response against previous responses that scored at particular levels on the provided rubric, for example, Claim/Counterclaim, Evidence Reasoning, Coherence, and Audience.
d. This model may be hosted in AWS as an API endpoint and does not make calls to services provided by third parties Student responses are evaluated by trained LLMs with one or more structured LLM prompts that direct the LLM to perform specific evaluations of the response that correspond to rubric categories and mastery levels, as described herein, and to provide feedback to the student according to the forms and precepts of the STW. The LLM prompts are constructed from AFS inputs (and the results of the evaluated sentences mentioned in item “c” above) in the LP back end, which creates and queues one or more asynchronous tasks to call OpenAI's API.

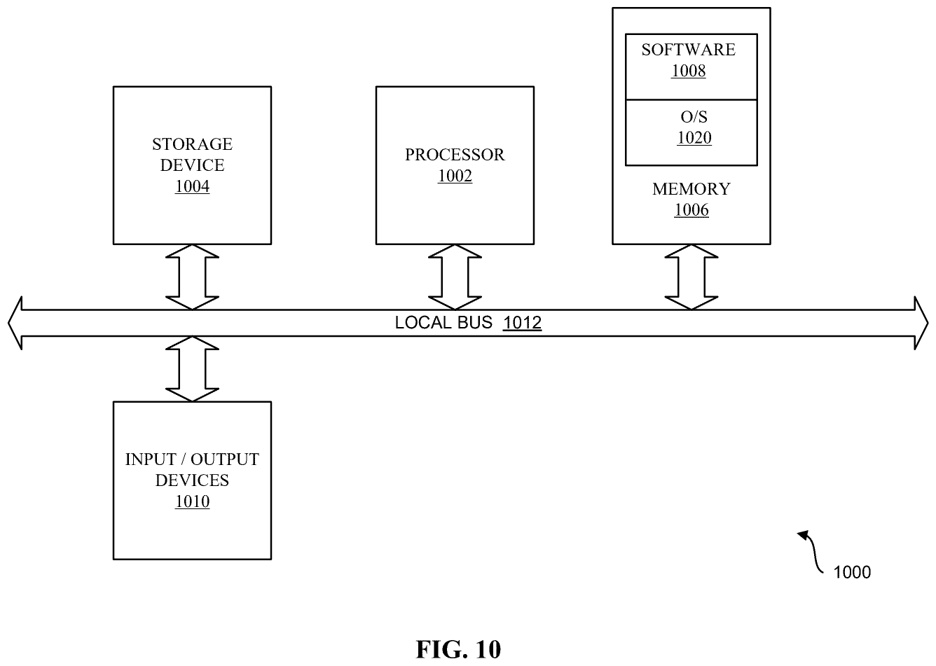

The present system for executing the functionality described in detail above may be a computer, an example of which is shown in the schematic diagram of FIG. 10. The system 1000 contains a processor 1002, a storage device 1004, a memory 1006 having software 1008 stored therein that defines the abovementioned functionality, input, and output (I/O) devices 1010 (or peripherals), and a local bus, or local interface 1012 allowing for communication within the system 1000. The local interface 1012 can be, for example, but not limited to, one or more buses or other wired or wireless connections, as is known in the art. The local interface 1012 may have additional elements, which are omitted for simplicity, such as controllers, buffers (caches), drivers, repeaters, and receivers, to enable communications. Further, the local interface 1012 may include address, control, and/or data connections to enable appropriate communications among the aforementioned components.

The processor 1002 is a hardware device for executing software, particularly software stored in the memory 1006. The processor 1002 can be any custom made or commercially available single core or multi-core processor, a central processing unit (CPU), an auxiliary processor among several processors associated with the present system 1000, a semiconductor based microprocessor (in the form of a microchip or chip set), a microprocessor, or generally any device for executing software instructions. While FIG. 10 shows the processor as a single unit, alternatively the processor may include two or more processing units distributed across two or more locations, for example, communicating via a communication network in addition to or in place of the local interface 1012.

The memory 1006 can include any one or combination of volatile memory elements (e.g., random access memory (RAM, such as DRAM, SRAM, SDRAM, etc.)), volatile memory elements (e.g., a hard drive, a solid state drive (SSD), a flash drive, an optical drive, tape) and nonvolatile memory elements (e.g., ROM, CDROM, etc.). Moreover, the memory 1006 may incorporate electronic, magnetic, optical, holographic, and/or other types of storage media. Note that the memory 1006 can have a distributed architecture, where various components are situated remotely from one another, but can be accessed by the processor 1002.

The software 1008 defines functionality performed by the system 1000, in accordance with the present invention. The software 1008 in the memory 1006 may include one or more separate programs, each of which contains an ordered listing of executable instructions for implementing logical functions of the system 1000, as described below. The memory 1006 may contain an operating system (O/S) 1020. The operating system essentially controls the execution of programs within the system 1000 and provides scheduling, input-output control, file and data management, memory management, and communication control and related services.

The I/O devices 1010 may include input devices, for example but not limited to, a keyboard, mouse/trackpad, haptic sensor, touchscreen, scanner, microphone, barcode reader, QR code reader, etc. Furthermore, the I/O devices 1010 may also include output devices, for example but not limited to, a printer, display (2D, 3D, virtual reality headset), transducer, etc. Finally, the I/O devices 1010 may further include devices that communicate bidirectionally via both inputs and outputs or a combined interface such as a full duplex serial bus (for example, a universal serial bus (USB)), for instance but not limited to, an interface for accessing another device, system, or network), a wireless transceiver, a copper, optical or wireless telephonic interface, a bridge, a router, or other device. The outputs may include an interface to control a manufacturing device, such as a 3D printer, a computerized numerical control (CNC) machine, and/or a milling machine, among others.

When the system 1000 is in operation, the processor 1002 is configured to execute the software 1008 stored within the memory 1006, to communicate data to and from the memory 1006, and to generally control operations of the system 1000 pursuant to the software 1008, as explained above.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub combination.

Similarly, while operations may be described herein as occurring in a particular order or manner, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Other implementations are within the scope of this disclosure.

What is claimed is:

1. A computer-based method for providing feedback to a student in response to a student text response to a provided lesson comprising a lesson passage and a lesson writing prompt, the feedback based on a large language model (LLM) prompt response from an LLM, the method comprising:
receiving a request for evaluation of the student text response comprising the student text response, a student identifier, and a lesson identifier, wherein the student identifier uniquely identifies the student and comprises a student competency level, and the lesson identifier comprises a lesson objective, the lesson passage, and the lesson writing prompt;
selecting an evaluation rubric from a plurality of evaluation rubrics indexed by one or more of the group of the student competency level, the lesson objective, and the lesson identifier;
initializing an evaluation data structure corresponding to the request for evaluation, the evaluation comprising a globally unique identifier (GUID), the request for evaluation, the evaluation rubric, an evaluation status, the LLM prompt, and a response;
formulating the LLM prompt based on the request for evaluation and the evaluation rubric;
providing the LLM prompt to the LLM;
receiving a response to the LLM prompt from the LLM;
updating the evaluation data structure with the response;
converting the response to feedback text strings; and
presenting the feedback text strings to the student in the context of the student text response,
wherein each rubric of the plurality of rubrics comprises a plurality of assessment criteria and a performance level for each criterion of the assessment criteria.

2. The method of claim 1, wherein the student competency level corresponds to an academic grade level.

3. The method of claim 1, further comprising checking the student text response for one or more of the group of a character count, a sentence count, a paragraph count, a language identifier, programming language, a computer script, and overlaps with the lesson passage.

4. The method of claim 3, further comprising rejecting the written response based on the checking the student writing response.

5. The method of claim 1, wherein the evaluation data structure, the provided lesson, and the plurality of rubrics are stored in a learn database.

6. The method of claim 1, further comprising training the LLM with data comprising the lesson, the rubric, and on a corpus of pre-evaluated student texts.

7. The method of claim 1, further comprising checking on the student text response selected from the group of a minimum character count, a minimum sentence count, a minimum paragraph count, a foreign language, a programming language, a computer script, and a duplication of lesson passage text.

8. A computer-based system for providing feedback to a student in response to a student text response to a provided lesson comprising a lesson passage and a lesson writing prompt, the feedback based on a large language model (LLM) prompt response from an LLM, the system comprising:
a graphical user interface (GUI) configured to display the lesson and receive the student text response;
a database (480) configured to store the student text, the lesson, a lesson rubric, and an evaluation record;
an application (420) in communication with the GUI, the database, and a first evaluator function, configured to:
receive a request for evaluation of the student text response comprising the student text response, a student identifier, and a lesson identifier, the student identifier uniquely identifies the student and comprises a student competency level, and the lesson identifier comprises a lesson objective, the lesson passage, and the lesson writing prompt;
use the student identifier and the lesson identifier to access the rubric from the database;
initialize the evaluation record data structure corresponding to the request for evaluation, the evaluation comprises a globally unique identifier (GUID), the request for evaluation, the rubric, an evaluation status, the LLM prompt, and the LLM response;
access the evaluation record in the database, formulate the LLM prompt based on the request for evaluation and the evaluation rubric; and
provide the LLM prompt to an LLM via the first evaluator function.

9. The system of claim 8, wherein the application is further configured to:
receive a response to the LLM prompt from the LLM;
update the evaluation data structure with the response; convert the response to feedback text strings; and
present the feedback text strings to the student in the context of the student text response via the GUI.

10. The system of claim 9, wherein the application (420) further comprises:
a front end (430) in communication with the GUI;
a back end (440) in communication with the front end; and
an asynchronous processor (450) in communication with the back end,
wherein the back end and the asynchronous processor have read and write access to the database.

11. The system of claim 10 wherein:
the application front end is configured to receive the request for evaluation of the student text response;
the application back end is configured to:
use the student identifier and the lesson identifier to access the rubric from the database; and
initialize the evaluation record data structure corresponding to the request for evaluation; and
the asynchronous processor is configured to:
access the evaluation record in the database, formulate the LLM prompt based on the request for evaluation and the evaluation rubric; and
provide the LLM prompt to the LLM via the first evaluator function.

12. The system of claim 11 wherein:
the asynchronous processor is further configured to:
receive the response to the LLM prompt from the LLM; and
update the evaluation data structure with the response
convert the response to feedback text strings; and
present the feedback text strings to the student in the context of the student text response via the GUI.

13. The system of claim 10, wherein the application back end communicates with the asynchronous processor via a job queue.

14. The system of claim 8, further comprising a second evaluator function configured to perform a check on the student text response selected from the group of a minimum character check, a minimum sentence check, a minimum paragraph check, a language check, a programming language check, a computer script check, and a duplication of lesson passage text check.

15. The method of claim 8, wherein the rubric comprises a plurality of assessment criteria, and a performance level for each criterion of the assessment criteria.
